(19) United States
(12) Patent Application Publication
(10) Pub. No.: US 2020/0268101 A1
(43) Pub. Date: Aug. 27, 2020

(54) INSOLE STRUCTURE WITH DECOMPRESSION

(71) Applicant: HSU-TONG TU, TAINAN CITY (TW)

(72) Inventor: HSU-TONG TU, TAINAN CITY (TW)

(21) Appl. No.: 16/453,003

(22) Filed: Jun. 26, 2019

(30) Foreign Application Priority Data
Feb. 21, 2019 (TW) 108105883

(51) Int. Cl. A43B 17/00; A43B 17/14; B32B 7/12; B32B 25/04

(52) U.S. Cl. CPC A43B 17/006; A43B 17/14; B32B 2307/744; B32B 25/042; B32B 2437/02; B32B 7/12

(57) ABSTRACT

The invention relates to an insole structure with decompression. It comprises an insole main body, and a guiding thin pad portion and a rear thin pad portion disposed on the insole main body, wherein the guiding thin pad portion provides capacity for an area given from metatarsophalangeal joints connected with a first phalanx and a first metatarsal till a fifth phalanx and a fifth metatarsal of the anterior sole, and the rear thin pad portion provides capacity for the calcaneus and have the first metatarsophalangeal joint stay at the lowest place while stepping.

### BACKGROUND OF THE INVENTION

### 1. Field of the Invention

The present invention relates to an insole structure with decompression which fits the human feet and smoothly guides the stress dispersion to reduce the pressure of the foot in the walking state or the resting state.

### 2. Description of Related Art

Generally, the insoles attached to the shoes are of uniform thickness, and some are added with a little thickness in the arch area to increase support. Only shoes with higher prices are fitted with hard blocks that secure the foot arch. In areas that are subject to maximum pressure on the heel and forefoot, a cushioning rubber block is also added to prevent the impact from the ground and protect the foot. However, this cushioning rubber block causes resistance during walking, wastes kinetic energy, and increases the force applied during walking.

As shown in FIG. 10, a normal gait flow while walking comprises three steps. First, the feet step out in front of the body and land by the outer sides of the soles to offset the inertial force of the oblique direction, withstand the vertical weight and transfer it into the force of moving forward. Second, the internal rotation of the soles causes the stepping position to be transferred from the outer sides of the feet to the inner sides, and the force is also transferred to the inner sides. In this process, the body moves to the front of the stepping position. Third, the stepping positions of the thumb balls receive the forward force from the previous steps and trigger the feet to pull out and step forward, thus completing a walking dynamic. It can be seen from the above gait flow that the human feet are not suitable for walking on a plane. This is also the main reason for the current increase in the population of arch collapse and the increase in the number of children with flat feet. Even in a standing or stationary posture, the foot arch is still bearing stress, and the stress on the foot arch is even increased when walking or running for a long time. Therefore, the flat-type stepping environment is not suitable for human walking.

The performance of a pair of sneakers depends mainly on the angle and curve of the tread surface at the bottom of the sole. Such important design is usually ignored by the general sneakers. Some sneakers with a forefoot AIR and a thick-soled insole obtain the required amount of sinking of the sole of the foot by the compression characteristics of the material itself, but in the lateral movement, the dislocation of the tread surface and the bottom of the insole easily causes foot eversion. As shown in FIG. 11, the thick-soled insole (5) has a shock-absorbing effect, but the incorrect angle of the insole (5) touching the ground will cause resistance and affect the most appropriate settlement position of the foot palm. After the insole (5) is laterally dislocated, the bottom arc at the inner side of the insole (5) rises when the foot is laterally stopped or redirected, causing the inner side of the foot palm to rise and turned outward and making it difficult to maintain stable body movements. In addition, the ankle may be sprained because the sole of the foot slides outward without support and the outside of the ankle lacks strength support and loses balance.

### SUMMARY OF THE INVENTION

In view of the above-mentioned problems, the object of the present invention is to provide an insole structure with decompression which fits the human feet and smoothly guides the stress dispersion to reduce the pressure of a foot in the walking state or the resting state.

The insole structure with decompression comprises an insole main body having a spherical groove and a low point at an inner side thereof and makes an outer side of the insole main body the main area of bearing force. Therefore, the internal and external forces can support the foot in a highly balanced state. Furthermore, the insole structure with decompression includes a rear thin pad portion to let the foot gravity center be located at three lower positions. Accordingly, the invention provides better condition while walking, which contains sufficient space for decreasing thickness of insole and then leads to action of stepping while walking and further increases stability while standing so that the foot pressure can be reduced in moving or resting state when the person wearing shoes.

The insole structure with decompression also comprises a guiding thin pad portion disposed on the insole main body so as to guide the sole of the foot tilting inward and reduce the pressure of the foot. Furthermore, the guiding thin pad portion maintains the dispersion path of the running stress of the foot, and achieves an easy and smooth decompression function.

### BRIEF DESCRIPTION OF THE DRAWINGS

FIG. 1 is a top view showing an insole structure with decompression according to the present invention;

FIG. 2 is a cross-section view showing a section A-A of the FIG. 1;

FIG. 3 is a cross-section view showing a section B-B of the FIG. 1;

FIG. 4 is a cross-section view showing a section C-C of the FIG. 1;

FIG. 5 is a cross-section view showing a section D-D of the FIG. 1;

FIG. 6 is a cross-section view showing a section E-E of the FIG. 1;

FIG. 7 is a cross-section view showing a section F-F of the FIG. 1;

FIG. 8 is a schematic diagram showing an insole structure with decompression and a foot stress dispersion direction according to the present invention;

FIG. 9 is a schematic diagram showing two anti-slip layers disposed on the insole according to the present invention;

FIG. 10 is a schematic diagram showing a normal gait flow while walking;

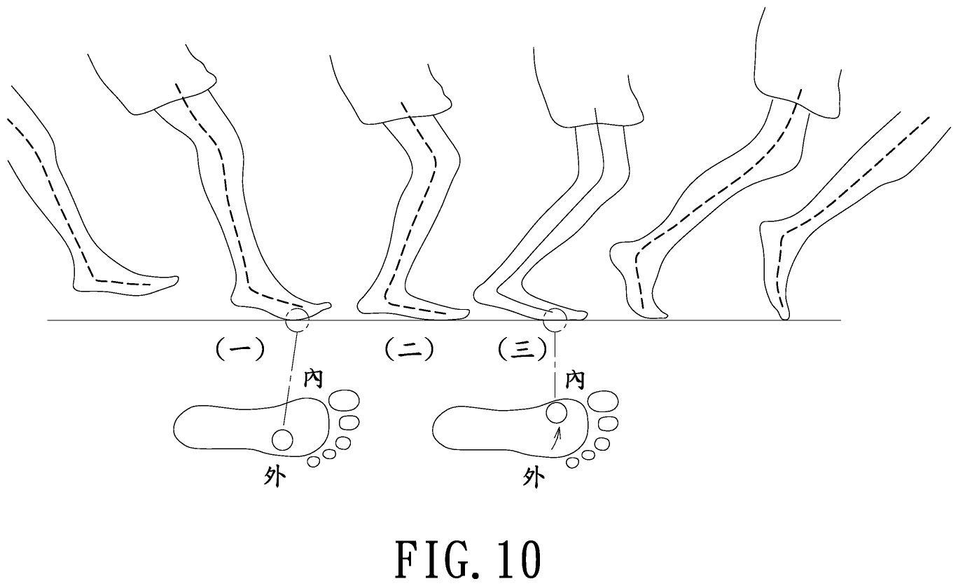

FIG. 11 is a schematic diagram showing a lateral force of a conventional high-thickness insole.

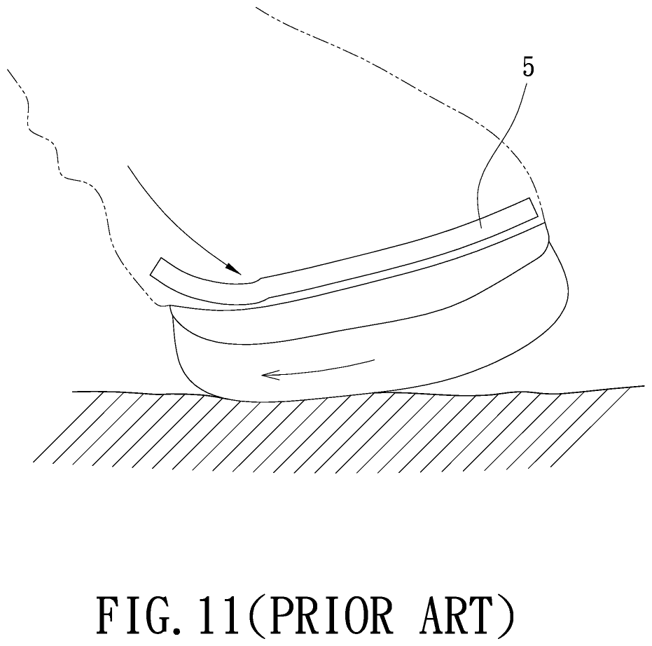

### DETAILED DESCRIPTION OF THE PREFERRED EMBODIMENT

Hereinafter, an exemplary embodiment of the present invention will be described in detail with reference to the accompanying drawings.

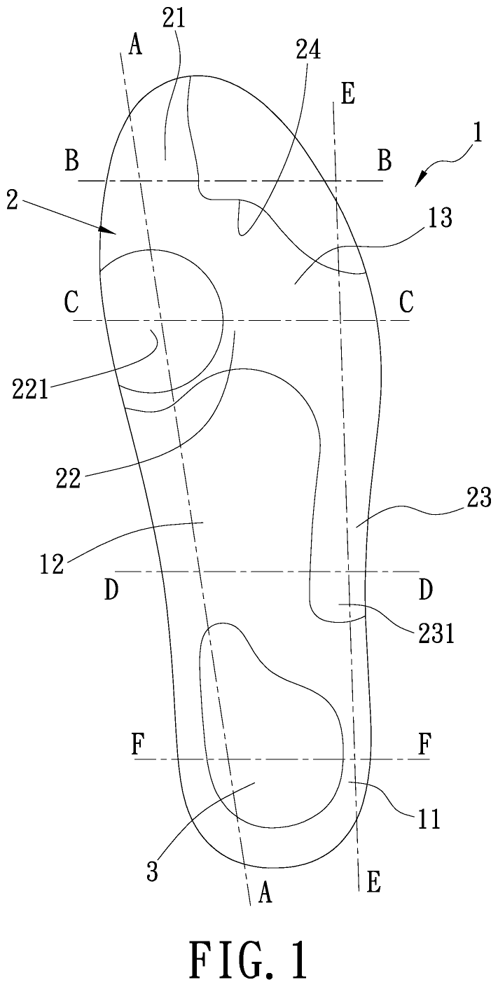

As showed in FIG. 1, a top view showing an insole structure with decompression according to the present invention is disclosed herein.

The insole structure with decompression comprises an insole main body (1), a guiding thin pad portion (2) and a rear thin pad portion (3). The insole main body (1) comprises a heel zone (11), an arch zone (12) and a forefoot zone (13), and a thickness of the insole main body (1) gradually decreases from the heel zone (11) to the forefoot zone (13). The forefoot zone (13) is tilted up. The guiding thin pad portion (2) is disposed between the arch zone (12) and the forefoot zone (13) of the insole main body (1), and the rear thin pad portion (3) is disposed on the heel zone (11) of the insole main body (1).

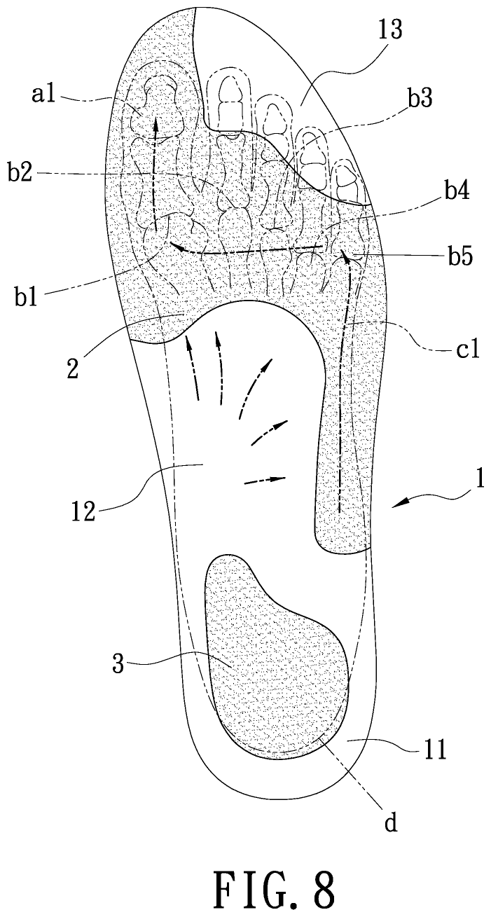

Referring to FIG. 1 and FIG. 8, the guiding thin pad portion (2) includes a thumb zone (21) to provide a space adapted correspondingly to a first phalanx (al) of a human foot, a transverse guide segment (22) connected to the thumb zone (21) to provide a space adapted correspondingly to a first to fifth metatarsophalangeal joints (b1, b2, b3, b4, b5), and a lateral force bearing segment (23) connected to the transverse guide segment (22) to provide a space adapted correspondingly to a fifth metatarsal (c1). The transverse guide segment (22) is inclined upward from the corresponding first metatarsophalangeal joints (b1) to the fifth metatarsophalangeal joints (b5). The thumb zone (21), the transverse guide segment (22) and the lateral force bearing segment (23) are connected to form the guiding thin pad portion (2). A thickness of the thumb zone (21) and a thickness of the transverse guide segment (22) are less than a thickness of the forefoot zone (13). The lateral force bearing segment (23) has a thickness less than a thickness of the arch zone (12). The transverse guide segment (22) is provided with a spherical groove (221) adapted correspondingly to the first metatarsophalangeal joint (b1) of the foot. The lateral force bearing segment (23) inclines from a junction with the transverse guide segment (22) toward a terminal thereof to form a low point (231).

The rear thin pad portion (3) is adapted correspondingly to a calcaneus (d) and depressed at the heel zone (11), so the rear thin pad portion (3) has a thickness less than a thickness of the heel zone (11).

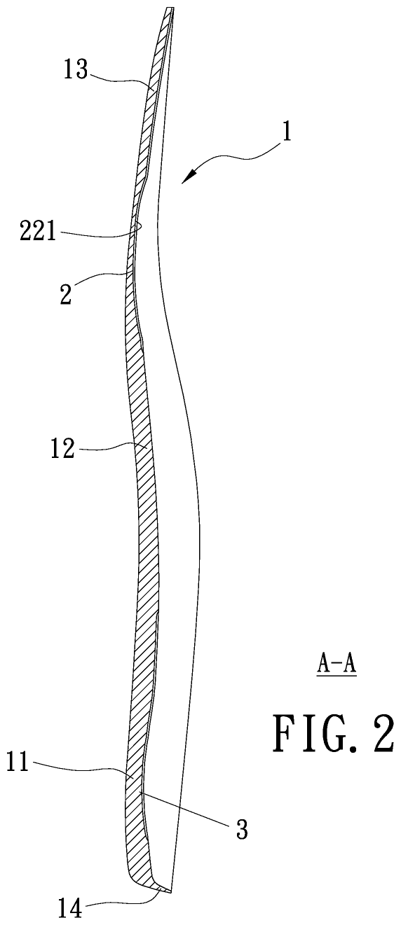

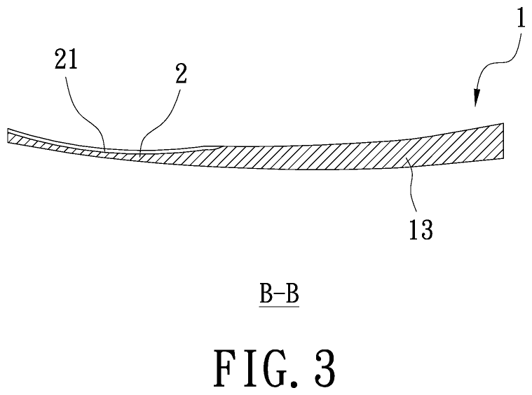

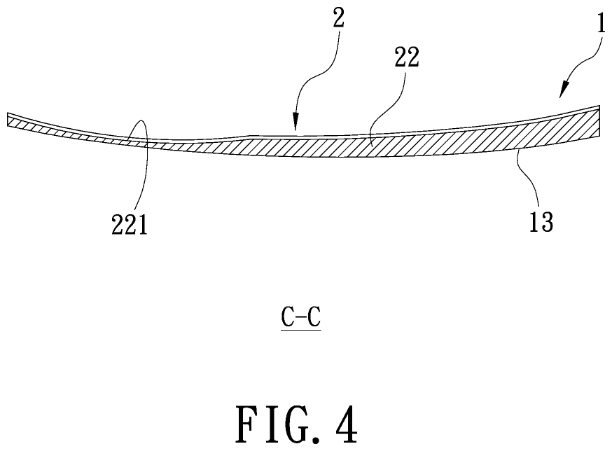

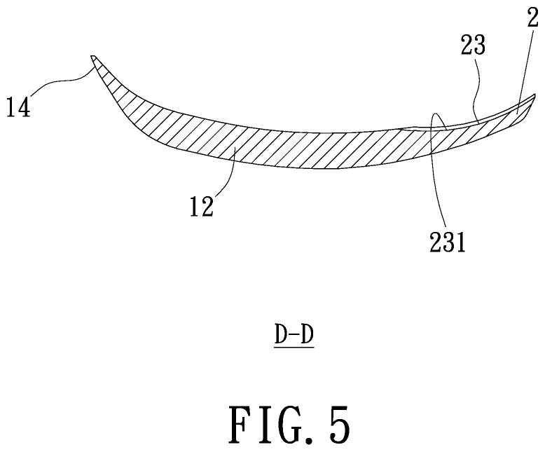

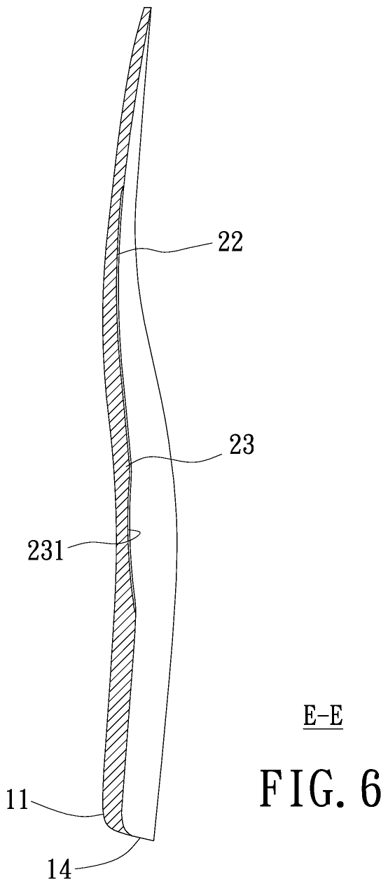

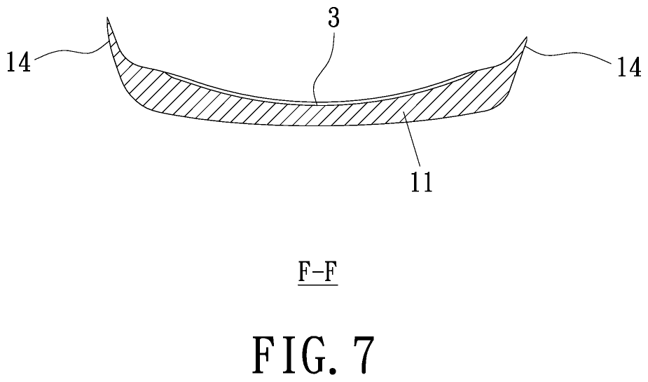

Referring to FIG. 1 to FIG. 8, the insole main body (1) of the present invention can be detachably placed into the shoe or directly integrated into an interior of the shoe body. The insole main body (1) has appropriate thickness and flexibility, and the thickness of the insole main body (1) can be adjusted according to changes of the bones and movements of the human foot.

For instance, the insole main body (1) is distributed with the heel zone (11) having a thickness of about 6.5 mm, the arch zone (12) having a thickness of about 5.5 mm, and the forefoot zone (13) having a thickness of about 4 mm. The thickness of the embodiment is the thickness measured at a certain point in the zone, and the zone is gradually thinned from the measured point. In order to allow the toes to lift up, the forefoot zone (13) tends to be thinner toward its front end and tilted up like a boat. Furthermore, the insole main body (1) is provided with the guiding thin pad portion (2) between the arch zone (12) and the forefoot zone (13) and the rear thin pad portion (3) on the heel zone (11). The guiding thin pad portion (2) is thinned on an end face of the insole main body (1) and is designed to accommodate the phalanx, the metatarsophalangeal joints and metatarsal or respond to activities of the phalanx, the metatarsophalangeal joints and metatarsal during walking. Therefore, the guiding thin pad portion (2) provides adequate and appropriate space for the metatarsophalangeal joints and the phalanx. The thumb zone (21), the transverse guide segment (22) and the lateral force bearing segment (23) are connected to form the guiding thin pad portion (2). The transverse guide segment (22) provides a space adapted correspondingly to the first, second, third, fourth and fifth metatarsophalangeal joints (b1, b2, b3, b4, b5) and is inclined upward from the corresponding first metatarsophalangeal joints (b1) to the fifth metatarsophalangeal joints (b5). Moreover, the transverse guide segment (22) is provided with the spherical groove (221) adapted correspondingly to the first metatarsophalangeal joint (b1) of the foot so as to provide an adequate space for the first metatarsophalangeal joints (b1) to be accommodated and allow the sole of the foot to be inclined toward the inner side (toward the direction of the first metatarsophalangeal joints (b1)).

Then, the lateral force bearing segment (23) which is close to the arch zone (12) supports the outer side of the sole of the foot to match the action of the spherical groove (221), so that a position of the first metatarsophalangeal joints (b1) on the guiding thin pad portion (2) is lower than a position of the fifth metatarsophalangeal joint (b5) on the guiding thin pad portion (2) and the sole of the foot is inclined to the inner side. A terminal of the lateral force bearing segment (23) is also recessed in response to the connection to the heel zone (11), so a low point (231) is formed at the terminal of the lateral force bearing segment (23) due to incline of the lateral force bearing segment (23) from a junction with the transverse guide segment (22) toward its terminal so as to provide a space adapted correspondingly to the fifth metatarsal (c1). Additionally, the calcaneus (d) is correspondingly accommodated in the rear thin pad portion (3) recessed at the heel zone (11). Thus, when the user wears the insole main body (1), the first metatarsophalangeal joint (b1) steppes on the spherical groove (221) due to the design of the spherical groove (221) and the low point (231) provided in the guiding thin pad portion (2). Therefore, the entire sole is deflected inward, and the fifth metatarsal (c1) of the foot is located on the lateral force bearing segment (23). With the calcaneus (d) stepping on the rear thin pad portion (3), the center of gravity of the sole is concentrated on three low positions, which becomes the center of gravity support when standing statically. In this way, the force is evenly distributed and the foot can be kept in a highly balanced state. The three-point support also allows the foot to be stepped on the insole main body (1) like a paw and provides strong stability when the foot is statically standing. Furthermore, in this state, the arch part is not subjected to tension and tension. Accordingly, the present invention guides the ankle joint, the knee joint and the hip joint to turn at appropriate angles to be in a natural and comfortable state, and can improve the foot lesion.

When the user wears the insoles for dynamic walking and exercising, the three steps of the normal gait flow are conducted. First, the feet step out in front of the body and land by the outer sides of the soles to offset the inertial force of the oblique direction. The foot stress is guided by the lateral force bearing segments (23) of the guiding thin pad portions (2) recessed on the insole main bodies (1) so that the insole main bodies (1) can withstand the vertical weight and transfer it into the force of moving forward. Second, after the soles touch the ground, the heels are gradually raised as the feet move forward. The internal rotation of the soles causes the stepping position to be transferred from the outer sides of the feet to the inner sides, and the force is also guided by the outer sides (the position of the fifth metatarsophalangeal joints (b5)) of the transverse guide segments (22) of the guiding thin pad portions (2) to transfer to the inner sides (the position of the first metatarsophalangeal joints (A)). Since the first metatarsophalangeal joints (b1) step at the lowest position of the spherical grooves (221), the stress can be smoothly guided to the inner sides. The spherical grooves (221) provide space for the first metatarsophalangeal joint (b1) activity and simultaneously withstand the user's weight and disperse stress when the soles are inclined inward. Third, the stepping positions of the thumb balls receive the forward force from the spherical grooves (221) and trigger the thumb zones (21) of the guiding thin pad portions (2) to pull out to make the feet step forward, thus completing a walking dynamic (the foot stress dispersion direction as shown by the arrows in FIG. 8).

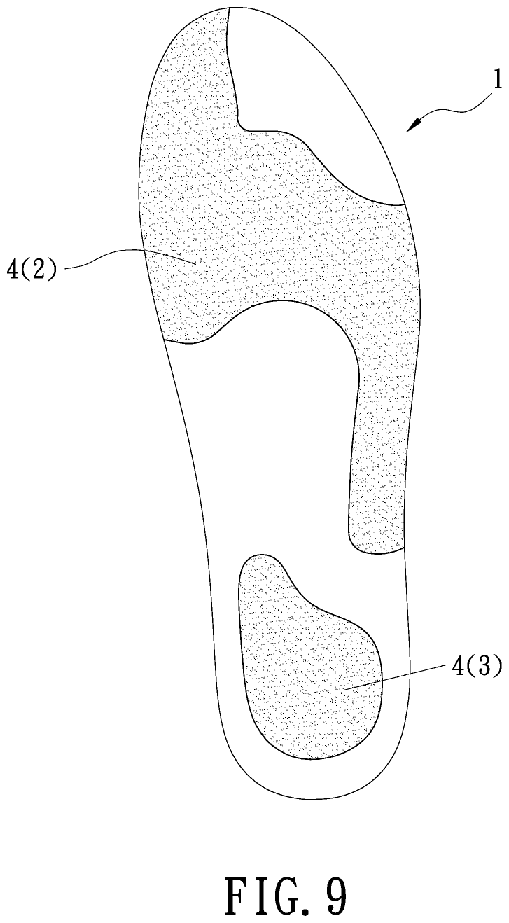

Furthermore, in order to achieve better coverage of the foot by the insole main body (1), a periphery of the heel zone (11) and a periphery of the arch zone (12) are respectively provided with a lifting edge (14). Referring to FIG. 9, a surface of the guiding thin pad portion (2) and a surface of the rear thin pad portion (3) are respectively provided with an anti-slip layer (4) so as to effectively prevent foot slippage during dynamic exercise. The anti-slip layer (4) is adhesively bonded to the insole main body (1) or directly sprayed onto the insole main body (1).

Additionally, a front edge of the transverse guide segment (22) of the guiding thin pad portion (2) is provided with an enlarging zone (24) so that the guiding thin pad part (2) can more firmly support the forefoot stepping.

According to the above description, in comparison with the traditional technique, the screw structure according to the present invention has the advantages as following:

1. The present invention comprises the spherical groove at the inner side of the insole and the low point closest to the outer side of the insole to be the main center of gravity, so that the inner and outer forces are maintained in a highly balanced state. Furthermore, with the rear thin pad portion, the three-point support allows the foot to step on the insole main body like a paw, which provide strong stability when the foot is statically standing.

2. The guiding thin pad portion of the present invention guides the sole to incline inward, reduces the pressure on the normal or everted foot and smoothly guides the stress dispersion to reduce the pressure of the foot in the walking state or the resting state.

What is claimed is:

1. An insole structure with decompression, comprising:
an insole main body having a heel zone, an arch zone and a forefoot zone, wherein a thickness of the insole main body gradually decreases from the heel zone to the forefoot zone, and wherein the forefoot zone is tilted up;
a guiding thin pad portion disposed between the arch zone and the forefoot zone of the insole main body and having a thumb zone adapted correspondingly to a first phalanx of a foot, a transverse guide segment connected to the thumb zone and inclined upward to be adapted correspondingly to a first to fifth metatarsophalangeal joints, and a lateral force bearing segment connected to the transverse guide segment and adapted correspondingly to a fifth metatarsal, wherein a thickness of the thumb zone and a thickness of the transverse guide segment are less than a thickness of the forefoot zone, and wherein the lateral force bearing segment has a thickness less than a thickness of the arch zone and inclines from a junction with the transverse guide segment toward a terminal thereof to form a low point; and
a rear thin pad portion disposed on the heel zone of the insole main body and adapted correspondingly to a calcaneus, wherein the rear thin pad portion has a thickness less than a thickness of the heel zone.

2. The insole structure with decompression as claimed in claim 1, wherein the transverse guide segment is provided with a spherical groove adapted correspondingly to the first metatarsophalangeal joint of the foot.

3. The insole structure with decompression as claimed in claim 1, wherein a front edge of the transverse guide segment of the guiding thin pad portion is provided with an enlarging zone.

4. The insole structure with decompression as claimed in claim 1, wherein a surface of the guiding thin pad portion and a surface of the rear thin pad portion are respectively provided with an anti-slip layer.

5. The insole structure with decompression as claimed in claim 1, wherein a periphery of the heel zone and a periphery of the arch zone are respectively provided with a lifting edge.

6. The insole structure with decompression as claimed in claim 2, wherein a front edge of the transverse guide segment of the guiding thin pad portion is provided with an enlarging zone.

7. The insole structure with decompression as claimed in claim 2, wherein a surface of the guiding thin pad portion and a surface of the rear thin pad portion are respectively provided with an anti-slip layer.

8. The insole structure with decompression as claimed in claim 2, wherein a periphery of the heel zone and a periphery of the arch zone are respectively provided with a lifting edge.

9. The insole structure with decompression as claimed in claim 4, wherein the anti-slip layer is adhesively bonded to the insole main body.

10. The insole structure with decompression as claimed in claim 7, wherein the anti-slip layer is adhesively bonded to the insole main body.

11. The insole structure with decompression as claimed in claim 4, wherein the anti-slip layer is directly sprayed onto the insole main body.

12. The insole structure with decompression as claimed in claim 7, wherein the anti-slip layer is directly sprayed onto the insole main body.
